(19) United States
(12) Patent Application Publication
(10) Pub. No.: US 2005/0061166 A1
(43) Pub. Date: Mar. 24, 2005

(54) Calender

(75) Inventors: Josef Pav, Krefeld (DE); Peter Svenka, Grefrath (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Eduard Kusters Maschinenfabrik GmbH & Co. KG, Krefeld (DE)

(21) Appl. No.: 10/936,414

(22) Filed: Sep. 7, 2004

(30) Foreign Application Priority Data
Sep. 19, 2003 (DE) 10343980.3

(51) Int. Cl. B30B 3/04; B30B 15/14

(52) U.S. Cl. 100/164; 100/168

(57) ABSTRACT

Calender for the treatment of a paper web, which comprises at least one roll stack that can be loaded from the end, has a stack plane and comprises end rolls and at least one intermediate roll, which comprise hard and soft rolls for forming working nips between a hard and a soft roll in each case, and some of the rolls being heatable, the roll stack having at least one intermediate roll, on whose periphery, on one roll stack side, two rolls that can in each case be displaced with respect to the stack plane bifurcate the roll stack.

### BACKGROUND OF THE INVENTION

The invention relates to a calender for treating a paper web.

Increasing the performance and productivity of the machines and installations for paper production assumes a substantial increase in the previous operating speeds and widths. In the process, there must be no qualitative loss on the paper web. Instead, there is even a demand for further evening of the web profiles.

### BRIEF SUMMARY OF THE INVENTION

It has now been observed that, in many cases, after a certain operating time transverse stripes occur on the paper web. As soon as these stripes become visible, the paper web is unusable and forms broke. Oscillation phenomena in the calender are viewed as the cause of this barring, as it is known.

According to the prior art, in particular DE 101 33 888 C1, DE 101 33 889 C1, DE 101 33 890 C2 and DE 101 33 891 C1, oscillations in a calender are virtually unavoidable, so that in order to compensate for these oscillations, it is proposed to offset at least one roll in the roll stack transversely with respect to the press plane to a specific extent and/or at specific times. Using such a remedial measure, however, it is possible to combat the symptoms but not the causes of barring. Offsetting a roll from the loading plane also has a serious fault as a result, namely a damaging change in the nip geometry with an uncontrolled change in the nip sizes, while damaging the resilient rolls. As a result, scatter of the web properties in the nip occurs, which is prejudicial to production.

It is therefore an object of the invention to provide a calender which is more economical in operation and, in the process, provides preferential calendering results.

This object is achieved by the features of Claim 1.

In this way, a calender for treating a paper web is provided which operates in a manner resistant to vibration and, as a result, permits high calendering speeds, which can lie far above 2000 m/min without loss in terms of predefined web properties occurring. The rolls that are offset with respect to the stack plane and bifurcate the roll stack support, block and stabilise the roll stack and, as a result, already prevent the production of vibration-exciting forces. The rolls which bifurcate the roll stack divide the loading plane, by which means roll displacements and deflections out of the loading plane are avoided and satisfactory nip geometries with radially oriented nip forces are ensured. The number of intermediate rolls and the temperature and compressive stress in the nip can be selected in accordance with the technological requirements.

The two rolls that bifurcate the roll stack can be displaced on the periphery of an intermediate roll and can thus assume various positions, specifically without changing the nip geometry. This also results in the following advantages.

The line loads in the nip can be changed by means of a displacement of the position of the rolls, so that, in spite of the linking of the rolls in the roll stack, an individual ability to adjust the line load at each end of the bifurcated roll stack is possible. The nip performances of the rolls that bifurcate the roll stack can be changed without the total nip performance being changed. This assists the quietness of running of the calender.

### BRIEF DESCRIPTION OF THE DRAWINGS

Further embodiments and advantages of the invention can be gathered from the following description and the subclaims.

FIG. 1 shows in schematic form the side view of a first exemplary embodiment of a calender for the two-sided treatment of a paper web,

FIG. 2 shows in schematic form the line loads in the nips of a calender according to FIG. 1 for a position of the rolls that bifurcate the roll stack with increasing line loads,

FIG. 3 shows in schematic form the line loads in the nips of a calender according to FIG. 1 for a position of the rolls that bifurcate the roll stack with the same line loads,

FIG. 4 shows in schematic form the line loads in the nips of a calender according to FIG. 1 for a position of the rolls that bifurcate the roll stack with decreasing line loads,

FIG. 5 shows in schematic form the side view of a second exemplary embodiment of a calender for one-sided treatment of a paper web,

FIG. 6 shows in schematic form the line loads in the nips of a calender according to FIG. 5 for a position of the rolls that bifurcate the roll stack with decreasing line load in the lower nip,

FIG. 7 shows in schematic form the line loads in the nips of a calender according to FIG. 5 for a position of the rolls that bifurcate the roll stack with increasing line load in the lower nip,

FIG. 8 shows in schematic form the side view of a third exemplary embodiment of a calender for one-sided treatment of a paper web,

FIG. 9 shows in schematic form the side view of a fourth exemplary embodiment of a calender for two-sided treatment of a paper web.

### DETAILED DESCRIPTION OF THE INVENTION

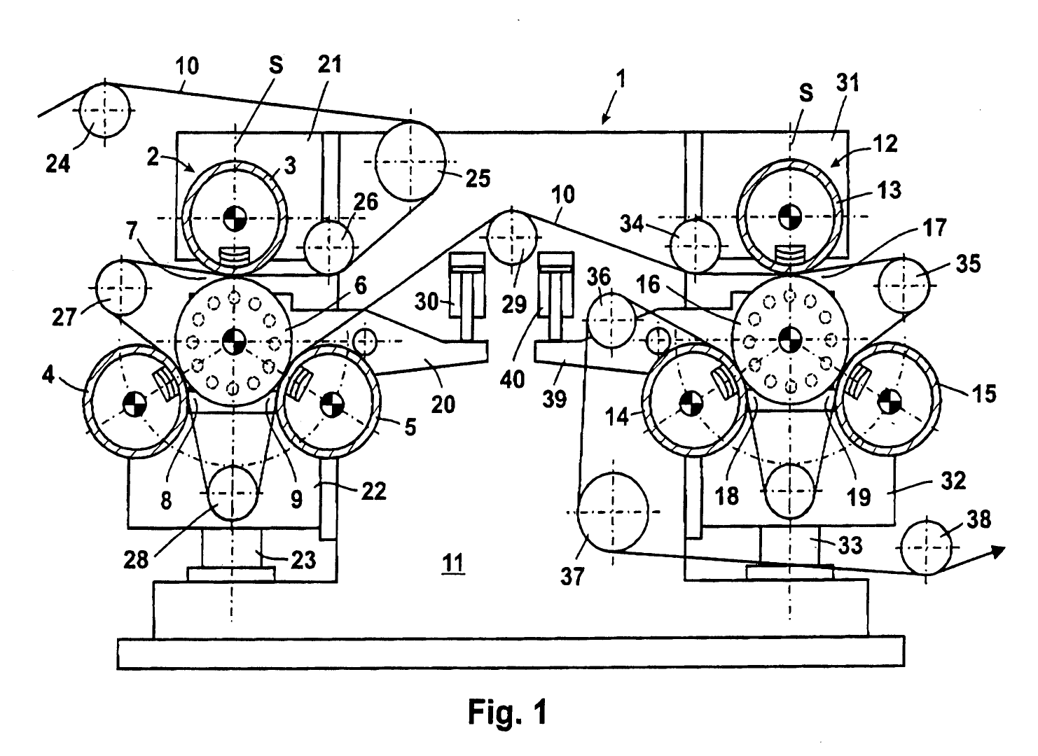

FIG. 1 shows a calender 1 for treating a paper web, in particular for paper suitable for gravure printing or paper which is to be calendered to a high gloss. The calender 1 comprises at least one roll stack 2 that can be loaded from the end and comprises end rolls 3, 4, 5 and at least one intermediate roll 6. The roll stack 2 has a stack plane S. The roll stack 2 comprises hard and soft rolls for forming working nips 7, 8, 9 between a hard and a soft roll in each case. In addition, some of the rolls are heated.

The roll stack 2 according to FIG. 1 comprises an upper end roll 3 and an intermediate roll 6, which are arranged in a (roll) stack plane S. The (roll) stack plane S runs vertically here but can also run obliquely. The end roll 3 is preferably formed as a soft roll, while the intermediate roll 6 is formed as a hard and heatable roll.

The roll stack 2 has at least one intermediate roll 6, on whose periphery on one roll stack side, here the roll stack side facing away from the upper end roll 3, two rolls 4, 5 respectively displaced with respect to the stack plane S are arranged, which bifurcate the roll stack 2, which also means that the loading plane is bifurcated or partitioned.

The rolls 4, 5 that bifurcate the roll stack 2 are lower end rolls, which form two lower roll stack ends. The roll stack 2 is therefore divided at the lower end, dividing the loading plane into two loading plane ends. The two rolls 4, 5 in each case form a nip 8, 9 with one and the same intermediate roll 6, the rolls 4, 5 in each case being linked to the rolls 3, 6, that is to say the intermediate roll 6 transmits the loading force of the upper end roll 3 to the two lower end rolls 4, 5.

The lower end rolls 4, 5 are formed as soft rolls. The working nips 7, 8, 9 are thus all soft nips, in which the paper web 10 running through the roll stack 2 is calendered. The soft rolls 3, 4, 5 are rolls with a resilient cover, whose material can be selected in accordance with the intended use.

The rolls 3, 4, 5, 6 of the roll stack 2 are fixed to a calender stand 11. The fixing is carried out via bearing devices, on which lever guides 20, as illustrated for the intermediate roll 6, or sliding guides 21, 22, as illustrated for the end rolls 3 and 4, 5, can act. In order to open and close the roll stack 2 and also to load the roll stack 2, the roll stack 2 can be loaded at least from one end. For this purpose, a hydraulic cylinder 23 is provided here. The upper end roll 3 is then arranged to be stationary.

Each roll 3 to 5 is preferably provided with its own power drive, whose drive torques can be set individually.

The upper end roll 3 and the two lower end rolls 4, 5 are also preferably formed as deflection controlled rolls.

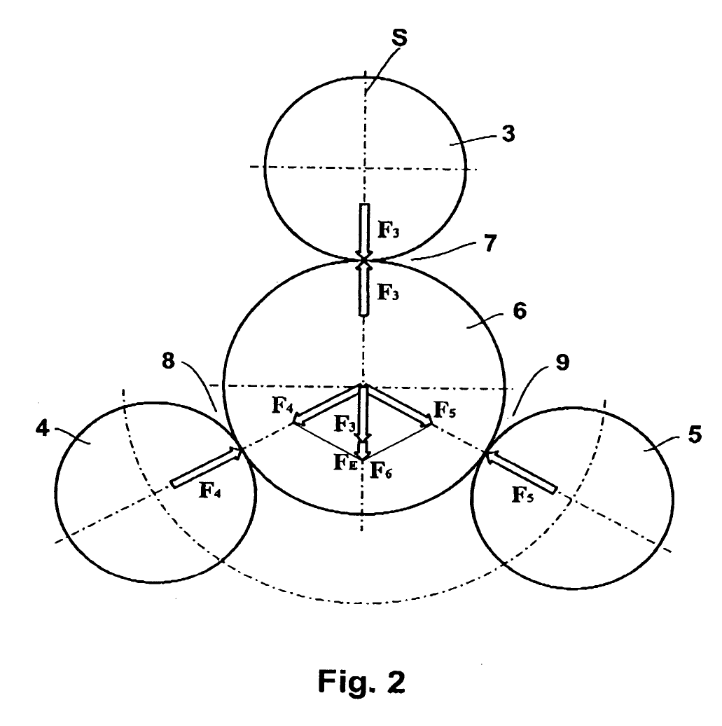

The two lower end rolls 4, 5 are preferably mounted on a common sliding guide 22, specifically in such a way that their position on the periphery of the intermediate roll 6 can be selected. By means of changing the position on the periphery of the intermediate roll 6, the loading forces in the working nips 8, 9 can be changed. By using force arrows, FIG. 2 shows, for a first position of the lower end rolls 4, 5 on the periphery of the intermediate roll 6, the contact forces F4 and F5 in the working nips 8, 9. A loading force F3 of the upper end roll 3, which results from the inherent weight of the roll 3 and/or from external loading forces, produces an equally large reaction force F3 in the intermediate roll 6. Added to this loading force F3 is an inherent weight force FE of the intermediate roll 6, forming a loading force F6 which is applied in the loading plane S.

The lower end rolls 4, 5 are arranged to be offset with respect to the stack plane S, so that the loading plane is bifurcated. In accordance with the law of the triangle of forces, the result is the contact forces F4 and F5, which correspond to the loading forces (line load) in the working nips 8, 9. In the position of the end rolls 4, 5 illustrated in FIG. 2, the line load in the lower working nips 8, 9 is higher than in the upper working nip 7.

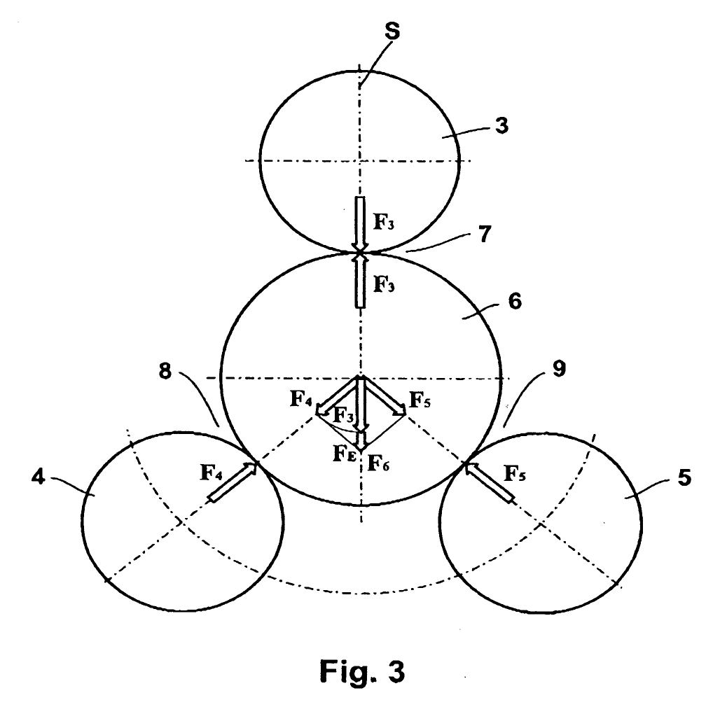

In the second position of the lower end rolls 4, 5 on the periphery of the intermediate roll 6, illustrated in FIG. 3, the contact forces F3, F4, F5, and therefore the line loads in all the working nips 7, 8, 9, are equal.

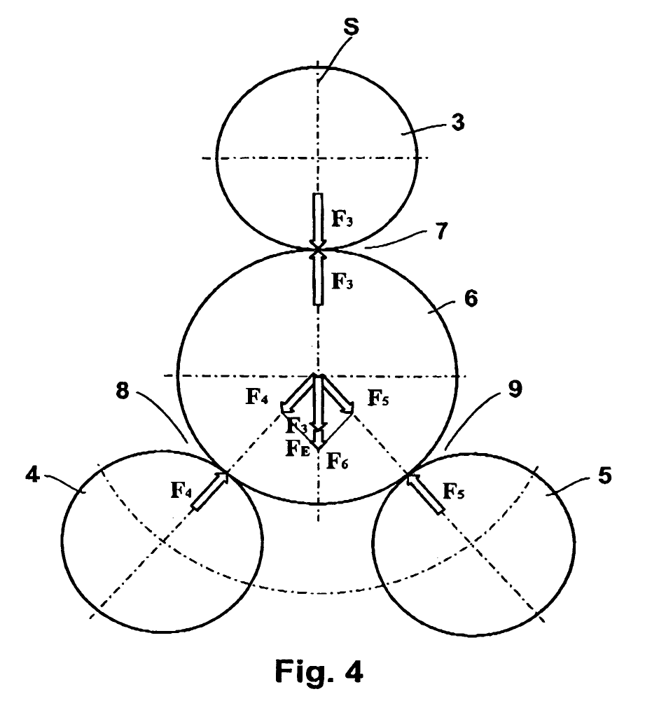

In the third position of the lower end rolls 4, 5 on the periphery of the intermediate roll 6, illustrated in FIG. 4, the contact forces in the lower operating nips 8, 9 are lower than in the upper working nip 7.

The absolute values of the loading forces can be set by means of the selection of the inherent weights of the rolls and/or by loading and relief devices 30. The rolls 4, 5 that bifurcate the roll stack 2 can preferably be displaced on the periphery of an intermediate roll with respect to the stack plane S between 30° and 60°.

Furthermore, the bifurcating rolls 4, 5 can be positioned variably on the periphery of an intermediate roll during the operation of the calender.

The two lower end rolls 4, 5 are preferably offset symmetrically with respect to the stack plane. Alternatively, they can also be offset asymmetrically with respect to the stack plane.

In order to guide the paper web 10 between the nips 7, 8, 9, guide rolls 24 to 28 are provided, it being possible for all the guide rolls for guiding the paper web to be equipped with a drive.

Since in each case only one side of the paper web 10 comes into contact with a hard roll, here the intermediate roll 6, in the nips 7, 8, 9 and experiences calendering there, in order to calender the other side of the paper web 10 a second roll stack 12 is provided, which corresponds to the construction of the first roll stack 2 and is arranged after the latter. Transferring the paper web 10 from the first roll stack 2 to the second roll stack 12 forms a reversing nip, since the side of the paper web which is calendered is changed. For this purpose, a deflection roll 29 can be provided.

The second roll stack 12 is preferably constructed in exactly the same way as the first roll stack 2. The above explanations relating to the roll stack 2 therefore apply in a corresponding way to the roll stack 12, comprising an upper end roll 13, an intermediate roll 16, two lower end rolls 14, 15 and with working nips 17, 18, 19. Lever and sliding guides 39, 31, 32 and the hydraulic cylinder 40 are used for fixing the rolls and for applying external loading forces. Guide rolls 34 to 38 serve to guide the paper web 10 through the working nips 17, 18, 19. The absolute values of the loading forces can be set independently of the first roll stack 2 by the selection of the inherent weights of the rolls and/or by loading and relief devices 40.

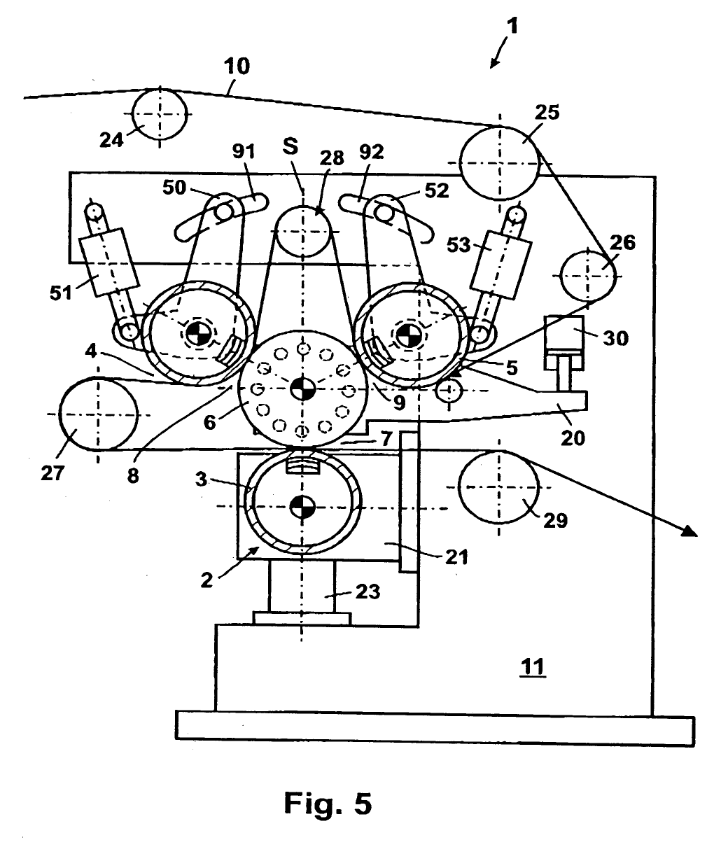

The exemplary embodiment of a calender 1 illustrated in FIG. 5 differs from the exemplary embodiment of a calender 1 illustrated in FIG. 1 only in the fact that the two rolls 4, 5 that partition the roll stack 2 are used as upper end rolls. In this case, each upper end roll 4, 5 is fixed to the calender stand 11 via a lever 50, 52 and is displaceably guided there in grooves 91 and 92. An associated loading and relief device 51, 53 is used to set the external loading forces. Also illustrated is only one roll stack 2 for a single-sided paper web treatment. A second roll stack for the treatment of the other paper web side can be connected after it.

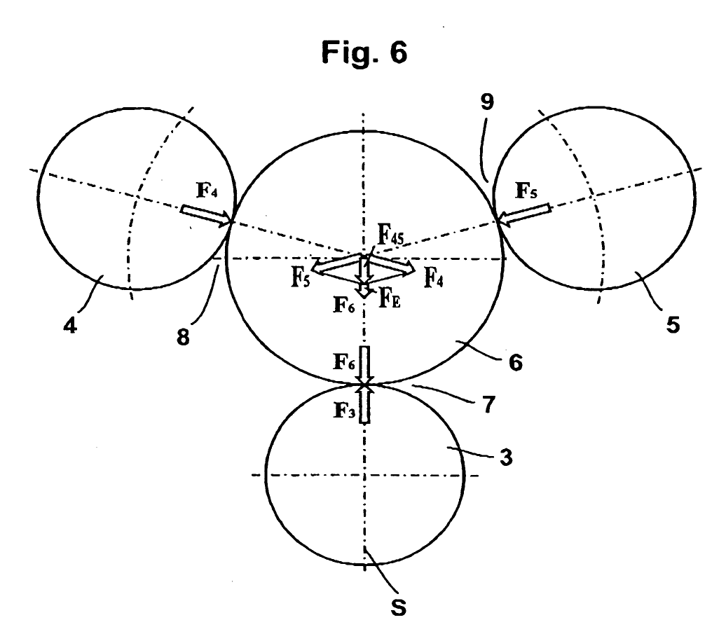

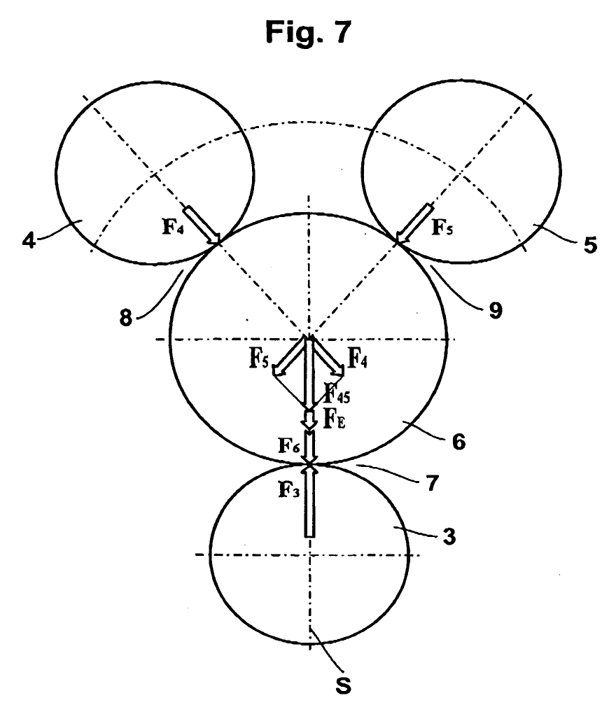

The position of the upper end rolls 4, 5 can be varied on the periphery of the intermediate roll 6. In accordance with the law of the triangle of forces, the loading forces F4, F5 in the working nips 8, 9 result in the resultant loading force F45 which, together with an inherent weight FE of the intermediate roll 6, result in a loading force F6 in the working nip 7. According to FIG. 6, the line load in the upper working nips 8, 9 is greater than in the lower working nip 7. By contrast, in the position of the rolls 4, 5 illustrated in FIG. 7, the line load in the upper two working nips 8, 9 is lower than in the lower working nip 7.

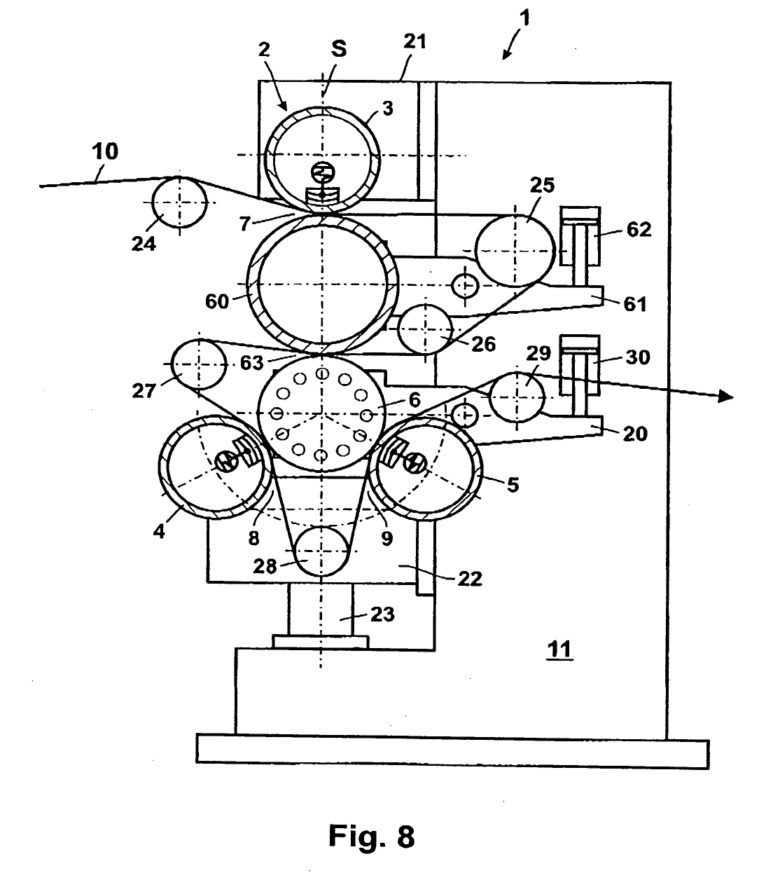

FIG. 8 shows a further exemplary embodiment of a calender 1, which differs from the calender illustrated and described in FIG. 1 in that the roll stack 2 has two intermediate rolls. In the stack plane, three rolls are therefore arranged above one another, namely the upper end roll 3, a first intermediate roll 60 and a second intermediate roll 6. The two intermediate rolls 6, 60 are mounted on the calender stand 11 via levers 20, 61. Loading and relief devices 30, 62 act on these levers 20, 61. The intermediate rolls 6, 60 form the working nip 63 between them. In order to form this working nip 63 as a soft nip in the same way as the working nip 7, in this 5-roll stack the upper end roll 3 is formed as a hard and heatable roll and the intermediate roll 60 as a soft roll. A second roll stack for treating the other paper web side can be connected after this roll stack 2.

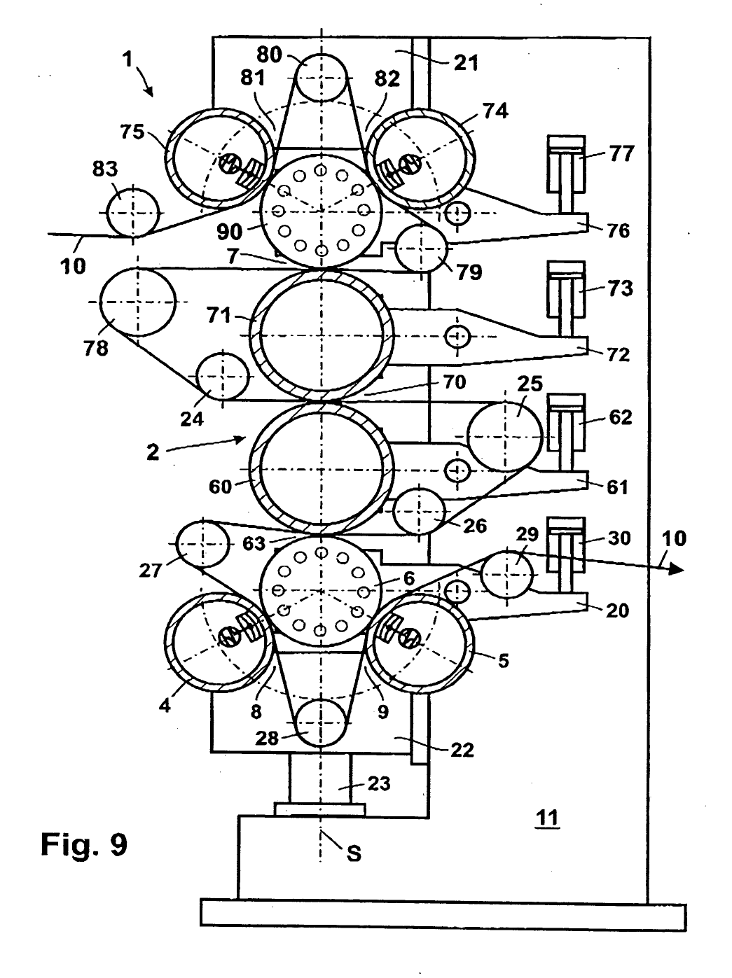

Finally, FIG. 9 shows a further exemplary embodiment of a calender comprising a roll stack 2 which integrates a reversing nip 70 between two soft intermediate rolls, in order to calender both sides of a paper web with one roll stack. Furthermore, the roll stack 2 has bifurcated ends at both ends. As described in relation to FIG. 1, two lower end rolls 4, 5 that bifurcate the roll stack 2 are provided. Furthermore, two upper end rolls 74, 75 that bifurcate the roll stack are provided, and a total of four intermediate rolls 6, 60, 71 and 90. The end rolls 4, 5 and 74, 75 that bifurcate the roll stack 2 are in each case formed as soft rolls and deflection controlled rolls, which are preferably equipped with an effective damping system. The intermediate rolls 6, 90 are formed as hard and heatable rolls, which are mounted on the calender stand 11 via levers 20, 76 and associated loading and relief devices 30, 77 and on whose periphery the bifurcating rolls 4, 5 and 74, 75 are displaceably positioned. The central intermediate rolls 60, 71 are formed as soft rolls, which are likewise fixed to the calender stand 11 via levers 61, 72 with associated loading and relief means 62, 73.

The paper web 10 runs through the working nips 81, 82, 7, 63, 8, 9 and the reversing nip 70. Between the rolls, the paper web 10 is guided by guide means 83, 80, 79, 78, 24, 25, 26, 27, 28, 29. Otherwise, the above explanations relating to FIG. 1 apply in a corresponding manner here.

According to an exemplary embodiment not illustrated, the roll stack can be bifurcated at a central intermediate roll.

In order to increase the quietness of running and therefore to increase the performance, each roll of a roll stack can be connected to a control loop, an overall control system being superimposed on the individual control loops. It is possible to control, in particular, changes in the position of the bifurcating rolls, the line loads in the nip, the drive powers of the power motors and/or the roll peripheral speeds.

According to a further embodiment the roll stack comprises hard and soft rolls for forming working nips between a hard and a soft roll, i.e. soft nips, as well as between two hard rolls, i.e., hard nips. Preferred is a roll stack comprising one hard nip and a number of soft nips.

All publications and patent applications mentioned in this specification are herein incorporated by reference to the same extent as if each individual publication or patent application was specifically and individually indicated to be incorporated by reference.

The invention now being fully described, it will be apparent to one of ordinary skill in the art that many changes and modifications can be made thereto without departing from the spirit or scope of the appended claims.

1. Calender for the treatment of a paper web, which comprises at least one roll stack that can be loaded from the end, has a stack plane and comprises end rolls and at least one intermediate roll, which comprise hard and soft rolls for forming working nips between a hard and a soft roll in each case, and some of the rolls being heatable, wherein the roll stack has at least one intermediate roll, on whose periphery, on one roll stack side, two rolls that can in each case be displaced with respect to the stack plane bifurcate the roll stack.

2. Calender for the treatment of a paper web according to claim 1, wherein the rolls that bifurcate the roll stack are optionally displaceably arranged on the periphery of the respective intermediate roll.

3. Calender for the treatment of a paper web according to claim 1, wherein the two rolls that bifurcate the roll stack are arranged symmetrically with respect to the stack plane.

4. Calender for the treatment of a paper web according to claim 1, wherein the two rolls that bifurcate the roll stack are arranged asymmetrically with respect to the stack axis.

5. Calender for the treatment of a paper web according to claim 1, wherein the two rolls that bifurcate the roll stack are formed as deflection control rolls.

6. Calender for the treatment of a paper web according to claim 1, wherein the roll stack is in each case bifurcated on both sides at the ends by in each case two rolls arranged on the periphery of an intermediate roll.

7. Calender for the treatment of a paper web according to claim 1, wherein the roll stack is bifurcated at a central intermediate roll.

8. Calender for the treatment of a paper web according to claim 1, wherein the two rolls that bifurcate a roll stack are formed as soft rolls.

9. Calender for the treatment of a paper web according to claim 1, wherein the roll stack has a reversing nip between two soft rolls.

10. Calender for the treatment of a paper web according to claim 1, wherein the rolls that bifurcate the roll stack can be displaced on the periphery of an intermediate roll with respect to the stack plane between 30° and 60°.

11. Calender according to claim 1, wherein the rolls of a roll stack in each case have their own power drive, whose drive torques can be set individually.

12. Calender according to claim 1, wherein the rolls of a roll stack are each connected to a control loop in order to change the line loads in the nip and/or the drive powers of drive motors of the rolls and/or the roll peripheral speeds.
